(19) United States
(12) Patent Application Publication
(10) Pub. No.: US 2022/0266248 A1
(43) Pub. Date: Aug. 25, 2022

(54) ASSAY SAMPLE VOLUME NORMALIZATION

(71) Applicant: Kenota Inc., Kitchener (CA)

(72) Inventors: Yiheng Qin, Mississauga (CA); Christopher J. Harder, Elmira (CA); Lucas Lim, Waterloo (CA); Mordechai Brodt, Ottawa (CA)

(21) Appl. No.: 17/675,027

(22) Filed: Feb. 18, 2022

Related U.S. Application Data
(60) Provisional application No. 63/151,409, filed on Feb. 19, 2021.

(51) Int. Cl. B01L 3/00; G01N 35/10; G01N 21/64

(52) U.S. Cl. CPC B01L 3/502715; G01N 35/1002; G01N 21/6428; B01L 2200/16; B01L 2300/0654; B01L 2300/0825; G01N 2021/6439

(57) ABSTRACT

A method and apparatus for assay sample volume normalization for a fluid sample applied to a diagnostic assay membrane to confirm the application of the sample fluid. The method can be used in manual, semi-automated, and automated analyser systems by applying a volume of a fluid sample having a fluorescence disruptor to a sample addition area of a membrane of an assay device having a fluorescent reporter and quantifying the change in fluorescence. Confirmation of sample fluid deposit and sample fluid volume calculation can be done by imaging the sample addition area to detect the disruption to fluorescence in the deposit area prior to running an assay.

### CROSS-REFERENCE TO RELATED APPLICATIONS

This application claims priority to United States provisional patent application U.S. 63/151,409 filed 19 Feb. 2021, which is hereby incorporated by reference herein in its entirety.

### FIELD OF THE INVENTION

The present invention pertains to the field of analytical chemistry and particularly to sample volume detection in an in vitro diagnostic device. The present invention provides a method for sample volume calibration for in vitro diagnostic devices, lateral flow assays (LFA) devices, and for sample calibration during diagnostics automation.

### BACKGROUND

Lateral flow assays, also known as immunochromatographic assays or strip tests, are immunoassays that are used to detect the presence or absence of a target analyte in a sample. Lateral flow assays are suitable for point-of-care testing, provide a result extremely quickly, and offer simple, user-friendly operation. Additionally, automation of lateral flow assay testing has proven to be a reliable method of testing for identification of target analytes in multiple samples in a short amount of time. Lateral flow assay strips based on the principles of immunochromatography exist for a wide array of target analytes, for example for measuring human chorionic gonadotropin, monitoring ovulation, detecting infectious disease organisms, analyzing drugs of abuse, and measuring other analytes important to human physiology. Lateral flow assay products have also been introduced for veterinary testing, agricultural applications, environmental testing, and product quality evaluation. While the first lateral flow assay tests provided qualitative results based on the presence or absence of a signal line indicative of the presence or absence of an analyte in a sample, test design has progressed toward semi-quantitative and quantitative assays with the integration of hand-held readers and automated high throughput analysers.

Most lateral flow test strips are modeled after existing immunoassay formats and are typically sandwich assays in which an antigen or compound of interest is immobilized between two layers of antibodies: a capture antibody and a detection antibody. In serum assays, antibodies are detected as indicators of various disease states and immunological status and detect the formation of a complex between a reporter particle that is free in the sample stream and a capture reagent that is bound to the membrane at a test line. Other microfluidic paper-based analytical devices can perform more complex tests, as well as parallel multiplexing tests, in multiple flow directions. The ability to work with smaller volumes is important when testing samples that are difficult to acquire in large volume, such as point-of-care tests for human health. In addition, adaptation of lateral flow assay to automated sample handling and detection with small sample volumes increases the number of samples that can be run on a single sample collected and offers the ability to do confirmatory assays for experiment confirmation and calibration.

Lateral flow assays traditionally rely on the use of antibodies that are conjugated to colored detection moieties, also referred to as reporters. Reporters can include, for example, visible and fluorescent dyes, latex beads, enzyme detection conjugates, gold nanoparticles, silver nanoparticles, titanium nanoparticles, europium fluorophores, and quantum dots. Immunochromatography colorimetric assays have been developed for rapid testing based on visual inspection or absorption measurement, however these can have low sensitivity and accuracy that is insufficient for quantitation of the amount or concentration of analyte in a sample.

In one example of a semi-quantitative lateral flow assay, U.S. Pat. No. 10,613,082 to Ehrenkranz describes a diagnostic test system having a lateral-flow chromatographic assay cassette that includes a capture ligand to capture at least one analyte of interest and at least one reporter for visualizing the interaction of the analyte of interest and the capture ligand. Further disclosed is a light source capable of transmitting at least one wavelength of light configured to yield a detectable signal from the at least one reporter to be captured by an optical detector and means for providing an at least two-point calibration curve for quantification of the at least one analyte of interest.

In both automated and non-automated systems calibrating the amount of sample applied to the membrane can be used in higher sensitivity quantitation of the concentration of analyte-of-interest in the sample. In one example of sample volume control U.S. Pat. No. 6,008,056 to Thieme describes an apparatus for assaying a preselected volume of sample on a chromatographic strip having a sample receiving reservoir for receiving a preselected volume of sample or a preselected volume of sample and reagent. The reservoir has an overflow outlet and a moat in communication with the overflow outlet for receiving the sample or the reagent when the reservoir is full such that dense sample first occupies the sample receiving reservoir with less dense excess sample being rejected.

In high throughput systems and in systems where quantitation of the concentration of analyte-of-interest in the original sample is important information for diagnostic analysis, an accurate measurement of applied sample volume is an important control factor in assay quantitation. These small volumes are ideal for sensitive or multiplexed tests, however introduce the added complexity of automated analysis systems having to accommodate for small volumes of air in the sample or other dispense inaccuracies. In particular, systems designed to handle very low volumes of fluid are often very sensitive to trapped air in the fluidic system which can cause significant differences in delivered fluid and thereby variation in the amount of applied sample, thus affecting the assay results. There remains a need for a method and apparatus for sample volume normalization in a lateral flow assay to calibrating the volume of dispensed sample for accurate quantitative analysis.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method, apparatus, and device for sample volume normalization and fluid sample calibration in a diagnostic assay device using fluorescence imaging to determine the sample volume added in the deposit area. Another object of the present invention is to provide a method for sample volume normalization in a diagnostic flow assay to provide more accurate and reproducible results of measurement of analyte-of-interest in the fluid sample in an automated or semi-automated diagnostic system.

In an aspect there is provided a method of fluid sample calibration comprising: applying a volume of a fluid sample to a sample addition area of a membrane of an assay device, the deposit area comprising a fluorescent reporter, the fluid sample comprising at least one fluorescence disruptor component that disrupts the fluorescence of the fluorescent reporter; and imaging the sample addition area to detect the disruption of fluorescence in the fluorescent reporter in the deposit area prior to running an assay, wherein the disruption of fluorescence of the fluorescent reporter in the sample addition area is indicative of the volume of the fluid sample deposited on the sample addition area.

In another aspect there is provided a method of fluid sample calibration comprising: applying a volume of a fluid sample to a sample addition area of a membrane of an assay device, the deposit area comprising a reporter, the fluid sample comprising at least one component that changes an optical characteristic of the reporter; and imaging the sample addition area to detect the optical characteristic of the reporter in the deposit area prior to running an assay; wherein the change in optical characteristic of the reporter in the sample addition area is indicative of application of the volume of the fluid sample to the sample addition area.

In an embodiment, the sample addition area is partially covered or fully covered by the reporter.

In another embodiment, the assay device is a lateral flow assay device further comprising, downstream the sample addition area, a detection area comprising at least one test line and at least one control line, and a wicking area

In another embodiment, the fluorescent reporter is one or more of a fluorescent dye, fluorescent latex bead, fluorescent enzyme detection conjugate, gold nanoparticle, silver nanoparticle, titanium nanoparticle, europium fluorophore, and quantum dot.

In another embodiment, the method further comprises determining whether the volume of fluid applied to the sample addition area is above an acceptable threshold or within an acceptable range.

In another embodiment, the method further comprises determining whether the volume of fluid sample applied to the sample addition area is within an acceptable range.

In another embodiment, the method further comprises determining the volume of the fluid sample applied to the deposit area. In an embodiment, determining the volume of the fluid sample applied to the deposit area is done by comparing the fluorescent signal of the reporter in the deposit area before the sample fluid is added to the fluorescent signal of the reporter after the fluid sample is added.

In another embodiment, the method further comprises adding a developing solution to run the assay.

In another embodiment, the method further comprises imaging an assay result at a test line; quantifying an amount of analyte of interest captured at the test line; and calculating a concentration of an analyte of interest in the sample fluid using the amount of analyte of interest captured at the test line and correcting for the calibrated volume of fluid sample applied to the sample addition area.

In another embodiment, the method further comprises calculating the volume of fluid sample added to the sample addition area by comparing the disruption of fluorescence of the fluorescent reporter to a standard curve.

In another embodiment, a quality control metric is applied based on the volume of fluid sample added to the sample addition area, and wherein the quality control metric determines the suppression of any subsequent analyte measurement made.

In another embodiment, the volume of the fluid sample is between about 0.2 μl and 10 μL.

In another embodiment, the fluid sample comprises blood.

In another embodiment, the fluid sample is diluted prior to application on the membrane.

In another embodiment, the fluid sample is a biological fluid sample.

In another embodiment, the fluid sample is applied by an automated device or syringe.

In another embodiment, the method further comprises applying developing solution to the flow assay membrane to run the assay and detect an analyte of interest.

In another aspect there is provided diagnostic analyser comprising: a fluid dispense area comprising a sample conduit for dispensing a sample volume in a sample spot onto a lateral flow assay membrane at a sample addition area, and a developing solution conduit; an imaging area comprising a light source for illuminating the assay membrane and an optical detection device for imaging the assay membrane; a shuttle comprising a movement mechanism to move the lateral flow assay membrane between the fluid dispense area and the imaging area, the lateral flow assay membrane comprising a sample addition area with a reporter, a detection area comprising a binding molecule, and a capture ligand capable of capturing and localizing at least one analyte of interest from the sample volume in the detection area of the assay membrane; and a processor assembly for quantification of the dispensed sample volume to the sample addition area based on an image collected by the optical detection device after sample addition and prior to an assay run, wherein the processor employs an interpretive algorithm stored in a computer readable format to (i) calculate a fluorescence intensity of the sample spot, and (ii) convert the sample spot fluorescence intensity to a quantification of the sample volume dispensed at the sample addition area.

In an embodiment, the analyser further comprises a control system for controlling movement of the shuttle.

In another embodiment, the algorithm compares the sample spot intensity to a calibration curve.

In another embodiment, the light source that emits at a fluorescent wavelength and the detector is a fluorescent detector.

In another aspect there is provided a method of sample volume normalization comprising: applying a volume of a fluid sample to a deposit area on a flow assay membrane, the deposit area comprising a fluorescent reporter, the fluid sample comprising at least one fluorescence disruptor component that disrupts the fluorescence of the fluorescent reporter; exposing the fluorescent reporter at the deposit area to light of a wavelength to excite the fluorescent reporter; imaging the membrane at the deposit area by detecting a fluorescence intensity of the fluorescent reporter in the deposit area; and determining the volume of the fluid sample applied to the deposit area by comparing the fluorescence intensity at the deposit area to a standard curve, wherein the fluorescence intensity in the deposit area is correlated with the volume of fluid sample applied in the deposit area.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is an isometric view of a lateral flow assay device;

FIG. 2 is a top view of a cartridge housing for a lateral flow assay device;

FIG. 3 is block diagram of an automated analyser system;

FIG. 4 is a block diagram of a fluid addition area and an imaging system for an automated analyser;

FIG. 5 is a front cross-sectional view of an optical imaging system for an automated analyser;

FIG. 6 is a flowchart for a method of sample volume normalization with a reporter;

FIG. 7 is a flowchart for a method of sample volume normalization with a fluorescent reporter with fluorescence quenching;

FIG. 8 is a set of photographic images of a deposit area with varying amounts of added sample;

FIG. 9 is a graph of spot intensity vs. dispensed sample volume;

FIG. 10 is a graph of sample spot width vs. dispensed sample volume; and

FIG. 11 is a photograph of the results port of low, medium, and high signal intensity results from three different assay runs.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

As used herein, the terms “comprising,” “having,” “including” and “containing,” and grammatical variations thereof, are inclusive or open-ended and do not exclude additional, unrecited elements, features, and/or method steps. These terms, when used herein in connection with a composition, device, article, system, use, or method, denote that additional elements, features, and/or method steps may be present. A composition, device, article, system, use, or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

As used herein, the terms “connect” and “connected” refer to any direct or indirect physical association between elements or features of the present disclosure. Accordingly, these terms may be understood to denote elements or features that are partly or completely contained within one another, attached, coupled to, disposed on, joined together, in communication with, operatively associated with, or fluidically coupled to, etc., even if there are other elements or features intervening between the elements or features described as being connected.

The term “sample” as used herein, refers to a volume of a liquid, fluid, solution, or suspension, intended to be subjected to qualitative or quantitative determination of any of its properties or components, such as the presence or absence of a component, the concentration of a component, etc. Typical samples in the context of the present invention as described herein are derived from human or animal bodily fluids such as but not limited to blood, plasma, serum, lymph, urine, saliva, semen, amniotic fluid, gastric fluid, phlegm, sputum, mucus, tears, stool, etc. Other types of samples are derived from human or animal tissue samples where the tissue sample has been processed into a liquid, solution, or suspension to reveal particular tissue components for examination. Other non-limiting examples of samples that can be used are environmental samples, food industry samples, and agricultural samples.

The terms “analyte” and “analyte of interest” in this disclosure refer to any and all clinically, diagnostically, or relevant analytes present in a sample. Analytes of interest can include but are not limited to antibodies, hormones, proteins, antigens, and other biologically relevant molecules. Some non-limiting examples of antibodies include antibodies that bind food antigens, and antibodies that bind infectious agents such as viruses and bacteria, for example anti-CCP, anti-streptolysin-O, anti-HIV, anti-hepatitis (anti-HBc, anti-HBs etc), specific antibodies against microbial proteins, and antibodies against known environmental molecules or allergens. The analyte of interest can also be a by-product of metabolism or a molecule secreted by cells as a response to any other genetic, drug or environmental factor.

The term “analyser” as used herein, refers to any apparatus enabling the processing of one or more analytical test or flow assay devices, and in which a plurality of test devices can be processed. The analyser can comprise a plurality of components configured for loading, incubating, testing, transporting, imaging, storing, and evaluating a plurality of analytical test elements in a manual, automated, or semi-automated fashion, and in which sample and/or other fluids may be automatically dispensed and processed substantially without user intervention. Analysers include but are not limited to clinical diagnostic apparatus and point-of-care type devices.

The term “reaction” as used herein, refers to any interaction which takes place between one or more components of a sample and at least one reagent or reagents on or in, or added to, the substrate of the test device, or between two or more components present in the sample. The term “reaction” is used to define the chemical or binding interaction taking place between an analyte and a reagent on the test device as part of the qualitative or quantitative determination of the analyte.

The term “sample volume normalization” as used herein, refers to the method of calibrating the sample volume added to the deposit area on a lateral flow assay device strip or flow assay membrane or other assay device. The calibration allows for quantification and precision in addition of the sample volume to the deposit area. In automated analyser and point-of-care devices, sample volume normalization can provide confirmation of sample addition to an assay membrane, resulting in fewer false negative tests. In addition, sample volume normalization can enable more accurate quantitation of the test results as well as extrapolation of concentration of the analyte of interest in the sample fluid as well as any original sample where the fluid originated.

Herein is described is a method, apparatus, and device for sample fluid volume normalization, confirmation, and calibration in an in vitro diagnostic analyser device using fluorescence imaging of an assay membrane having a fluorescent reporter after application of a fluid sample and prior to the assay run. By applying a sample fluid comprising a fluorescence disruptor to a deposit area having a fluorescent reporter, a fluorescence optical characteristic of the fluorescent reporter on the membrane changes upon interaction with the fluid sample. The volume of applied fluid sample can then be measured by proxy by measuring the change in the optical characteristic of the fluorescent reporter or disruption or change to the reporter fluorescence at the deposit area. In one embodiment, by imaging the deposit area comprising the fluorescent reporter after sample has been applied, the change in fluorescence of the reporter in the deposit area can be detected, and the volume or volume range of fluid sample applied to the deposit area can be determined by comparing the change in fluorescence of the reporter in the deposit area to a standard curve. The positive confirmation of presence of an appropriate amount of added fluid sample in the deposit area prior to assay run can further give an indication that a volume of sample in the acceptable volume range for the assay has been applied, reducing the number of false negative results. In automated systems where the applied sample volume can be variable, and especially in assays for which very small amounts of sample are used, such as less than 10 μL, ensuring that an appropriate amount of sample volume was added to the test membrane confirms that sample was indeed applied and that a negative assay result is a true result.

Increasingly it is preferred, especially while scaling up diagnostic assays including lateral flow assays for high throughput, that the dispensing of the samples to be analysed is conducted in automated or semi-automated fashion, and in which sample elements are automatically dispensed and processed substantially without user intervention. In principle automation of high throughput assays should standardize results as well as increase processing speed, and automation of diagnostic assays reduces cost, batch size and assay reproducibility. However fluid handling in automated devices can be highly sensitive to disruption, such as by entrapped air, and the tiny amounts of sample applied to each assay membrane can vary widely. Distinguishing a negative test from one where the device has failed to deliver sample can be difficult to discern. Using the determined sample volume applied to the deposit area and the detected results in the results area on the assay membrane of a diagnostic device, such as a lateral flow assay device, the concentration of analyte of interest in the sample fluid can also be calculated.

The presently described method, and associated system and device, uses fluorescence signal disruption or fluorescence signal quenching to determine the sample volume added in the deposit area to provide a more accurate measurement of the concentration of analyte-of-interest in the fluid sample. The present method, device, and system can thus be used to visualize the interaction of the sample added to the membrane to determine whether an appropriate volume of sample has been added to the membrane to provide improved accuracy during high throughput testing. In another embodiment, calculating the exact volume of sample added can be used to correct an assay result to the dispensed volume to enable a more accurate concentration of the analyte of interest in the sample to be determined. In one preferable embodiment, the detector on the deposit area of the assay membrane can be a fluorescent detector and the method can be used with a sample comprising a component that quenches, hides, or diffuses the fluorescence of the fluorescent detector. Fluorescence imaging with illumination at an appropriate wavelength can be used to correlate the fluorescence intensity in the deposit area before and after sample addition to the deposit area, and the volume of fluid sample or volume range of fluid sample applied in a deposit area can be determined by comparing the difference in fluorescence intensity before and after sample addition and quenching. Fluorescent measurement has been found to improve sensitivity by one to two orders of magnitudes in comparison with color-based measurement.

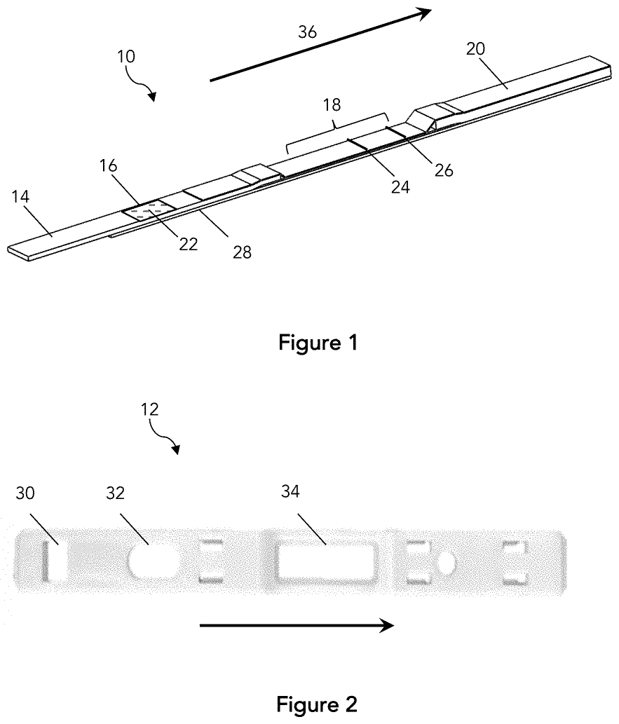

FIG. 1 is an isometric view of a lateral flow assay device 10 which can be used with the present method and apparatus. The diagnostic test device described herein comprises a flow assay membrane comprising, in series along a flow path: a sample addition area 16 comprising a reporter 22; a detection area 18 comprising a binding molecule; and a wicking area 20. The assay device 10 is preferably in a cartridge housing. In use, one or more reporter 22 is used for sample volume normalization of a sample fluid, and the reporter 22 is deposited on the sample addition area 16. The binding molecule binds an analyte of interest, or a molecule that binds the analyte of interest, which is detected by a detection conjugate that can be the same or different than the reporter. The chromatographic strip or membrane in assay device 10 can also comprise and be fluidly connected to an application pad (not shown) having a detection area with a reporter, a conjugate release pad, and an absorbent pad. The extracted sample and other compounds are transferred across the lateral flow membrane by a chromatographic mechanism, such as by capillary action. A sample addition area 16 at one side of the lateral flow assay device 10 extends to the results or detection area 18 and wicking area 20, with the arrow showing the direction of flow of developing solution, also referred to as the flow path. The sample addition area 16 has a reporter 22 deposited thereon such that upon application of fluid sample through a sample port in the cartridge and onto the sample addition area 16, an optical characteristic of the reporter 22 will be modified in the location where the sample fluid has been applied which can be detected by optical detection means. For the purposes of this description, a reporter is an agent which is detectable with respect to its physical distribution and/or the intensity of the signal it delivers.

The defined fluid flow path 36, shown with an arrow, extends from the sample addition area 16 to the wicking area 20, and the sample addition area 16 disposed at one end of the lateral flow assay device 10 forms a portion of a fluid flow path extending through detection area 18. Once developing solution is added to the sample addition area 16, partially overlapping with addition area or upstream of the sample addition area at the optional conjugate pad 14, the sample and developing solution flows along the defined fluid flow path 36 due to capillary action between the sample addition area 16 and the wicking area 20. The sample addition area 16 on the diagnostic assay device 10 is the area on the lateral flow membrane strip where a sample to be analysed is dispensed. In a typical lateral flow assay, a stationary or bound binding molecule at results line 24 indicates the presence (or absence) of an analyte of interest, with relative line intensity being correlated with the amount of analyte of interest in the sample applied to the assay strip. The control line 26 also comprises a stationary or bound (immobilized) reporter binding molecule which binds with a reporter molecule once the reporter passes the control line 26 to indicate a valid test. The lateral flow assay device or assay test strip is referred to in terms of the exemplary embodiment shown, however it will be readily apparent that other flow assay test strip device designs and possible variants of these designs could also be similarly configured for interrelationships with the presently described method and device for sample volume normalization in a lateral flow assay, particularly in an automated analyser system, as herein described. In particular, the assay device can have multiple test lines, multiple control lines, and other modifications.

To run the assay, sufficient developing solution, also referred to as mobile fluid, is applied either directly to the sample addition area after imaging of the sample addition spot, or to a developing solution reservoir in a cartridge, in which case an optional conjugate pad 14 can carry the developing solution from the reservoir down the flow path of the lateral flow assay strip. In the embodiment shown, conjugate pad 14 at the first or upstream end of the fluid flow path 36 draws sample fluid in the desired direction along the lateral flow test strip from a reservoir in the cartridge and acts as a wick to provides a capillary force to draw up and move developing solution into the membrane of the test strip and through the sample addition area 16 of the assay device. The conjugate pad 14 can include a porous material such as, for example, nitrocellulose. Conjugate pad 14 is optionally bendable, shown extending off from an optional solid support 28, to accommodate a lowered buffer well in the assay cartridge base and further positioned by an optional wick guide in the assay cartridge base and/or lid.

Downstream from the detection area 18 along the fluid flow path 36 is the wicking area 20 in fluid communication with the detection area. Wicking area 20 at the opposite end of the fluid flow path 36 draws sample fluid in the desired direction along the flow assay strip 10. The wicking area 20 is an area of the assay strip 10 with the capacity of receiving liquid sample and any other material in the flow path, such as for example unbound reagents, wash fluids, etc. The wicking area 20 provides a capillary force to move the liquid sample through and out the detection area of the assay strip. The wicking area can include a porous material such as, for example, nitrocellulose. The wicking area can further include non-capillary fluid driving means, such as using evaporative heating. Optionally a hydrophilic foil or layer can be positioned directly onto at least a portion of the wicking area 20 or other part of the assay device to enhance the overall flow rate or process time of a sample applied to the flow assay device. The lateral flow assay strip can also comprise an optional filter material (not shown) which can be placed within the sample addition area 16 to filter particulates from the sample or, in the case where the sample comprises blood, to filter blood cells from blood so that plasma can travel through the device.

Obvious asymmetry in the design of the flow assay strip also provides ease of assembly of the flow assay strip within an assay cartridge and provides a directionality of the flow path so that the flow assay strip is properly aligned inside the cartridge. The lateral flow assay test strip can also optionally comprise one or more flow channels, optionally cut or pressed into the surface of the membrane substrate. The fluid flow path may also include additional separate areas containing one or more reagents, antibodies, or detection conjugate, as well other areas or sites along the fluid path that can be used for washing of the sample and any bound or unbound components thereof. The assay membrane can also be optionally treated to adjust the sample properties, such as, for example, by pH level or viscosity.

Components of the flow assay devices such as the physical structure of the device described herein can be prepared from, for example, copolymers, blends, laminates, metallized foils, metallized films or metals, waxes, adhesives, or other suitable materials known to the skilled person, and combinations thereof. Alternatively, device components can be prepared from copolymers, blends, laminates, metallized foils, metallized films or metals deposited on any one or a combination of the following materials or other similar materials known to the skilled person, examples of which include but are not limited to paraffins, polyolefins, polyesters, styrene containing polymers, polycarbonate, acrylic polymers, chlorine containing polymers, acetal homopolymers and copolymers, cellulosics and their esters, nitrocellulose, fluorine containing polymers, polyamides, polyimides, polymethylmethacrylates, sulfur containing polymers, polyurethanes, silicon containing polymers, other polymers, glass, and ceramic materials. Alternatively, components of the assay device can be made with a plastic, polymer, elastomer, latex, silicon chip, or metal. In one example, the elastomer can comprise polyethylene, polypropylene, polystyrene, polyacrylates, silicon elastomers, or latex. Alternatively, components of the device can be prepared from latex, polystyrene latex or hydrophobic polymers. In one example, a hydrophobic polymer can be used for the cartridge or membrane support comprising, for example, polypropylene, polyethylene, or polyester. Alternatively, components of the device can comprise TEFLON®, polystyrene, polyacrylate, or polycarbonate. Alternatively, device components can be made from plastics which are capable of being embossed, milled or injection molded, or from surfaces of copper, silver and gold films upon which may be adsorbed various long chain alkanethiols. The structures of plastic which are capable of being milled or injection molded can optionally comprise one or more of, for example, polystyrene, polycarbonate, polyacrylate, and cyclo-olefin polymer. The assay device or lateral flow assay strip can also comprise an optional filter material which can be placed within and/or downstream the sample addition area to filter particulates from the sample, for example to filter or trap blood cells or particulate matter from blood so that added plasma can travel through the device.

Various configurations of diagnostic assay devices and lateral flow assay devices are known, including but not limited to variation in device dimensions, materials, porosity of the substrate, presence or absence of topographical features on the substrate, channel shape and configuration, and method of manufacturing the channel. The particular lateral flow assay strip 10 is referred to throughout this description in terms of an exemplary embodiment, however it will be readily apparent that other device designs and possible variants of these designs could also be similarly configured.

The described lateral flow assay device 10 is particularly useful for immunoassay formats which are typically sandwich assays wherein the membrane is coated with a capture antibody or protein, sample is added, and any antigen or antibody present in the sample binds to the capture molecule. In standard immunoassays, a detecting antibody binds to antigen in the sample, an enzyme-linked secondary antibody binds to the detecting antibody or to the antigen, and a substrate in the fluid is converted by the enzyme into a detectable form. In an automated system, detection can be done automatically using a visualization system such as a camera or other detection system. The visualization system can also comprise one or more light sources emitting the same or different wavelengths of light, one or more lenses for focusing and enlargement of the test area, and one or more optical filters for eliminating or selecting specific wavelengths of light.

FIG. 2 illustrates a top perspective view of a cartridge housing 12 for a lateral flow assay device having openings for developing solution port 30, sample port 32, and results port 34. In a preferred embodiment the lateral flow assay device is almost entirely encapsulated by a cartridge or housing, enabling sample addition at a sample addition area and detection of reaction at the detection area through apertures in the cartridge lid. The cartridge 30 can comprise a cartridge bottom, cartridge side walls, and cartridge end walls to provide additional solidity and durability to the lateral flow assay strip. A cover or lid can be optionally included. A results port 34 in the cartridge is positioned around the detection area to enable one or more detector to detect reaction in the detection area. The term “detector” as used here refers to devices that are configured to detect and/or measure signals gathered by the detector and/or other devices/components in the detection area of the lateral flow assay strip.

In use, sample addition area on the lateral flow assay device receives sample, optionally via a dispenser in an automated analyser, through the sample port 32 in the cartridge lid. The cartridge protects and holds the lateral flow assay strip and can be adapted for automated transfer in an automated analyser for high throughput lateral flow analysis. Sample applied to the sample addition area interacts with the reporter and changes an optical characteristic of the reporter species deposited on the sample addition area such that the location where sample was added to the sample addition area can be visualized by an optical detector, optionally assisted with one or more sources of illumination. In one example, the reporter in the sample addition area is a fluorescence reporter and the sample fluid comprises a component for quenching the fluorescence of the reporter. In another example, the sample fluid can comprise a dye that binds with or changes an optical characteristic of the reporter, such as, for example, the colour of the reporter in the area where sample has been applied. In another example, the sample fluid could contain a pigment that decreases the detectable component of the signal of the reporter, such as, for example, the addition of whole blood. In another example, the reporter could exclude the reporter from an area by molecular interactions such as hydrophobicity.

Fluorescence is the ability of certain chemicals to give off visible light after absorbing radiation at a wavelength that the chemical can absorb. To detect a fluorescence signal, the fluorescent reporter on the membrane is exposed to light from an excitation light source at a wavelength that the reporter can absorb, and an imaging system images light at the emission wavelength of the reporter. Fluorescence disruption mechanisms work in the present method and system to change or disrupt a signal imaged from a fluorescent reporter deposited on a membrane. The disruption can work by, for example, blocking the light reaching the reporter from the excitation light source, blocking the light emitted from the fluorescent reporter back to the imaging system, changing the location of the reporter on the membrane, or quenching of the fluorescent reporter. Fluorescence disruption is primarily caused by fluorescence quenching, fluorescence displacement, fluorescence dilution, fluorescence obfuscation, or a combination thereof. Fluorescence dilution occurs when a sample volume is added and results in solubilization of the fluorescent reporter, resulting in a colour change in the area wetted by the sample, changing the fluorescence background in the sample addition area compared to before sample was added. Fluorescence quenching occurs when the fluorescence disruptor in the sample fluid decreases the fluorescence intensity of a given substance by interfering with energy transfer in the fluorescent reporter. A variety of processes can result in fluorescence quenching, such as excited state reactions, energy transfer, and complex-formation. Fluorescence displacement occurs when the fluorescent reporter is moved out of a region causing a reduction in fluorescence in that region, or a rise in fluorescence outside of the wetted region. Fluorescence obfuscation occurs when the fluorescence disruptor either physically blocks light from the excitation light source reaching the reporter, or blocks fluorescent reemission light from reaching the imaging system. In one example of fluorescence obfuscation, red bloods cells are inherently dark, so when the sample fluid comprises red blood cells, these can block fluorescent light from either reaching the reporter or block outgoing reemitted light, or both.

Preferably, the reporter on the sample addition area also serves as the reporter or detection molecule for the immunoassay reaction and reacts with the analyte of interest either directly or through a cascade of one or more reactions to generate a detectable signal such as a colored or fluorescent signal. In one embodiment, the reporter also includes conjugate material. The term “conjugate” means any moiety bearing both a detection element and a binding partner. Preferably, the reporter in the sample addition area comprises formulations of but not limited to europium, a radio-labelled molecule, a fluorochrome, or colloidal gold particles. The sample can be dispensed onto the sample addition area in a manual, automated, or semi-automated manner. Once sample has been added to the assay membrane and the sample addition area has been imaged for sample volume normalization, developing solution is applied through developing solution port 30 so that the developing solution can be drawn by capillary action down the flow path of the diagnostic assay device to run the assay. The developing solution travels along the flow path to the reaction area or detection area on the assay membrane substrate, which is visible through results port 34 in the cartridge lid.

One or more additional reagent or detection agent or molecule other than the reporter on the sample addition area of the assay strip can also be added to the sample or pre-loaded onto the membrane before or during the running of the assay in a location on the membrane between the sample addition area and upstream the detection area, which in some immunoassay devices is referred to as a conjugate release area. The sample and a reagent plume will be contained in the fluid flow and travel along the fluid path. The reagent plume can contain any of the reagent materials that have been dissolved or deposited along the flow path of the lateral flow assay strip, or those added in the sample, developing solution, or a combination thereof. The reagent plume can include the conjugate having both the detection element and binding partner, in which case it is often referred to as a conjugate plume. For example, if the analyte is a specific protein, the conjugate may be an antibody that will specifically bind that protein to a detection element, such as a fluorescence probe. The capture element could then be another antibody that also specifically binds to that protein. In another example, if the marker or analyte is DNA, the capture molecule can be, but is not limited to, synthetic oligonucleotides, analogues, thereof, or specific antibodies. Other suitable capture elements include antibodies, antibody fragments, aptamers, and nucleic acid sequences, specific for the analyte to be detected. A non-limiting example of a suitable capture element is a molecule that bears avidin functionality that can bind to a conjugate containing a biotin functionality. The detection area can also include multiple detection areas and include one or more markers. The detection or results area includes one or more bound reagents reactive for detecting a target component within the sample area.

In addition, an interrupting reagent can be used to wash the sample and other unbound components present in the fluid flow path into the wicking area. These additional reagents and/or reporters can either be added on the reagent area prior to use and potentially dried on the reagent area, added to the reagent area just prior to use using a reagent metering device on the analyser, added into the developing solution or the developing solution port, or a combination thereof. The reagent can also be added via an optional reagent metering device in the analyser. Reagents that can be added include but are not limited to binding partners such as antibodies or antigens for immunoassays, detection agents, conjugated antibodies, tagging molecules, fluorophores, biomarker specific antibodies, DNA and RNA aptamers with or without resonance energy transfer (RET) pairs and respective target analytes, substrates for enzyme assays, probes for molecular diagnostic assays, and auxiliary materials such as materials that stabilize the integrated reagents, materials that suppress interfering reactions, and the like.

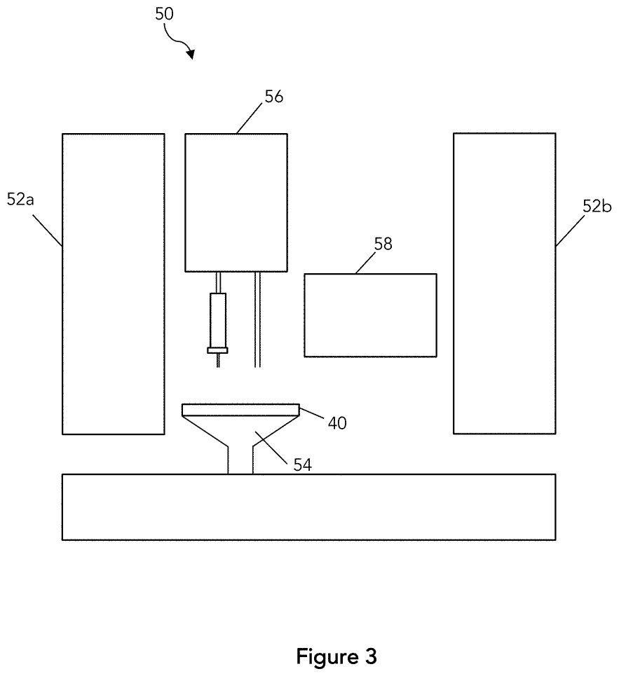

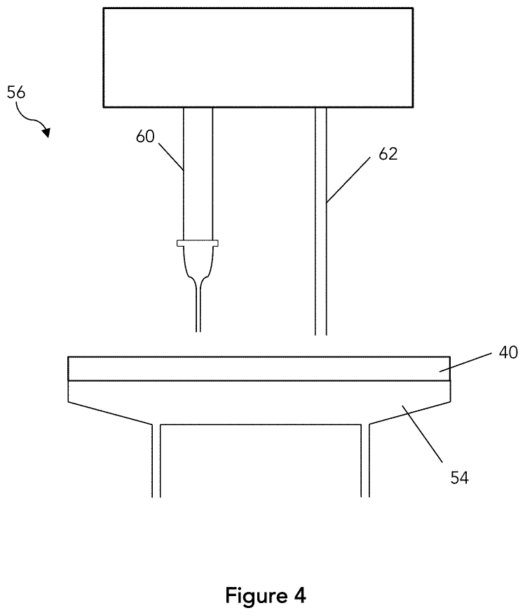

FIG. 3 is a block diagram of an automated analyser 50 capable of handling a plurality of lateral flow assay cartridges at a time. Cartridge shuttle 54 shuttles a lateral flow assay cartridge 40 comprising an assay device between first hopper 52a and second hopper 52b, where cartridges are stored vertically during loading, before assay runs, during assay development, and after the assay run. Cartridge shuttle 54 engages with a lateral flow assay cartridge 40, which has a lateral flow assay device inside the cartridge housing, and comprises one or more movement mechanism, such as a translational and/or elevational conveyance motor, that can move the assay cartridge 40 between cartridge hoppers 52a, 52b, as well as into and out of the fluid dispense system 56 and imaging system 58 of the automated analyser 50. The cartridge shuttle 54 in an automated analyser system can be positioned below imaging system 58. In this position the assay cartridge 40 housing a lateral flow assay device is positioned for illumination and imaging in the automated analyser. A movement mechanism can accurately move the cartridge shuttle 54 to below the fluid dispense system 56 where the lateral flow assay device is positioned for dispense of sample or developing solution. To ensure that the assay cartridge 40 is in the desired location for receiving fluid, imaging, as well as in alignment with the cartridge hoppers 52a, 52b, the cartridge shuttle 54 can be operatively connected with one or more mechanical mechanism capable of fine control changes in translation and elevation. Fine positioning and location control of the cartridge shuttle 54 with a control system enables adjustments to the alignment of the cartridge during operation to optimize imaging, fluid control, and storage, which can further improve assay results. It is understood that other combinations and configurations of the analyser can be used with the presently described assay device and method.

FIG. 4 is a block diagram of an example fluid addition system 56 of an automatic analyser. During sample dispense, a lateral flow assay cartridge 40 is brought into alignment with the fluid dispense system 56 by a cartridge shuttle 54 such that sample fluid can be transferred from a sample loading device, shown in this embodiment as sample syringe 60 into a sample port of the cartridge 40. When the sample volume is dispensed onto the lateral flow assay membrane it appears as a spot, referred to herein as the sample spot. The lateral flow assay membrane having a sample volume dispensed thereon is then shuttled to the imaging area for imaging the spot size and spot intensity of the sample spot. Once the sample spot has been imaged for processing to determine the dispensed sample volume the control system delivers developing solution to the lateral flow assay cartridge through developing solution conduit 62 to run the assay. After the assay is run the lateral flow assay cartridge is shuttled back to the imaging area for imaging the results area on the lateral flow assay membrane.

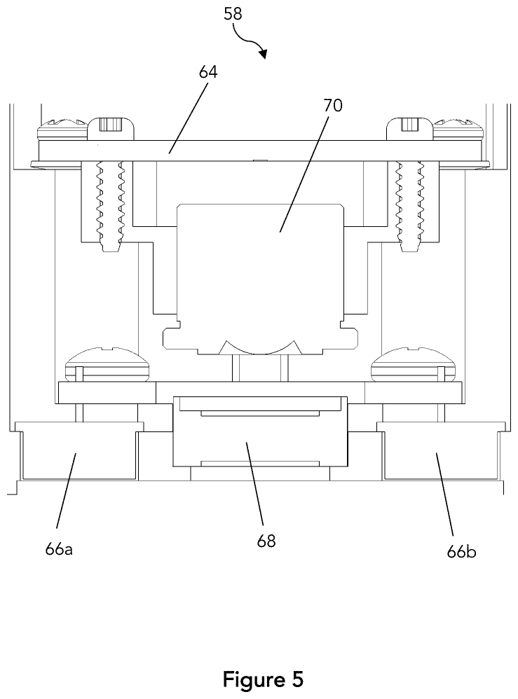

FIG. 5 is a front cross-sectional view of an optical imaging system 58 for an automated analyser. The imaging system 58 has one or more illumination device or light source 66a, 66b for illuminating an area on the lateral flow assay cartridge or assay membrane in the imaging area of the analyser. The illumination device or light source can be one or more light emitting diode (LED) light sources, array of LED lights, or any other light source that fits into the required footprint of the analyser. An optical imaging device 64 is positioned to take an optical image of the illuminated assay device. The imaging device can be, for example, a camera, charge-coupled device (CCD) sensor, or complementary metal oxide semiconductor (CMOS) sensor. The light captured by the imaging device can be visible, infrared, and of single or of multiple wavelengths. The system can also include one or more lenses 70 for focusing or sizing the imaging area. The system can also include one or more optical filter 68 for eliminating or selecting specific wavelengths of light for accurate measurement of the reporter molecule.

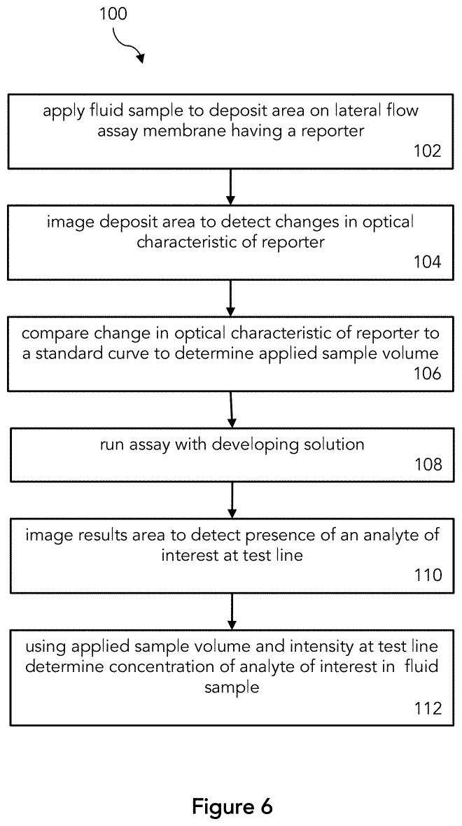

FIG. 6 is a flowchart for an example method of sample volume normalization 100 with a reporter. As previously described, fluid sample is applied to the sample addition or sample deposit area on a lateral flow membrane having a fluorescent reporter deposited thereon 102. The deposit area is then imaged to detect changes in optical characteristic of reporter 104 compared to what the sample deposit area would look like with no sample added. The change in optical characteristic of the reporter is then compared to a standard curve for intensity, spot size, or both spot intensity and spot size to determine the applied sample volume 106. This step is called the sample volume normalization, and the calculated sample volume based on the sample spot size and spot intensity can be used together with the assay results to determine the amount of analyte of interest in the applied sample. In particular, an additional measurement of line intensity at the test line can be used to calculate the concentration of the analyte of interest in the sample solution based on the known volume of sample fluid added to the ample addition area. Alternatively, a sample normalization calculation can be done that measures the change in optical characteristic to determine if the volume of applied sample is within an acceptable minimum and maximum volume range to run the assay accurately. This puts a bound on the volume range required to run the test and ensures that a sufficient volume within the acceptable volume range is added to the assay device. The calculated concentration of analyte of interest in the sample volume can also be used to calculate the concentration of analyte of interest in the original sample based, for example, on a known dilution of the applied sample compared to an undiluted sample. Developing solution is then applied to the lateral flow assay membrane to run the assay 108. After the assay is complete, an image is taken of the results area to detect presence of an analyte of interest at one or more test lines and preferably also at a control line 110. The calculated applied sample volume and/or intensity at the test line can then optionally be used to determine concentration of analyte of interest in the fluid sample 112. In particular, by imaging the applied volume by spot size or signal intensity or both, comparing the applied volume to a calibration value, calibrating volume to the change in test line signal, and correcting the test line signal based on volume an accurate measurement of concentration of analyte of interest in the sample can be discerned.

To calculate volume at the sample addition area, disruption of the fluorescent reporter deposited at the sample addition area must be measurable. The colour, contrast, appearance, tone, shade or any other disruption of the reporter that changes the signal and helps algorithmically bound the region on which the fluid sample has been dispensed can be used. A characterization of known fluid sample volumes vs. area or intensity of the disrupted reporter at the sample spot is performed in order to create a standard curve, estimate its imprecision, and setup the method for interpolation to determine the fluid sample volume of an unknown dispense.

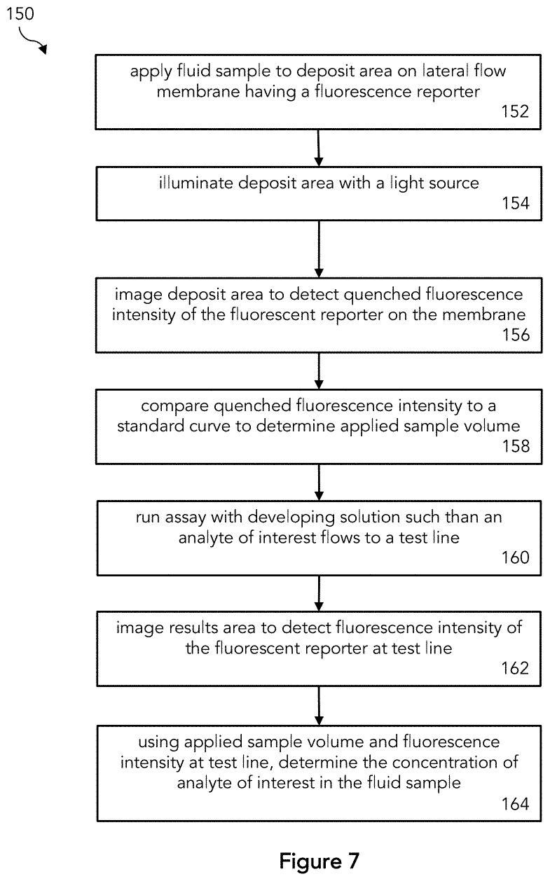

FIG. 7 is a flowchart for a method of sample volume normalization with a fluorescent reporter 150 and a sample fluid that causes a change in fluorescence intensity or quenching of fluorescence of the fluorescent reporter at a sample addition area. In a preferred embodiment, a fluorescent reporter is deposited on the assay membrane and the fluorescent signal disruption or signal quenching caused by the interaction of a fluorescence interrupting component of the sample to disrupt the fluorescence of the fluorescent reporter provides a dark area on the sample addition area where the sample with the fluorescence disruption component has been added. Quenching of fluorescence is shown here as one example of fluorescence disruption, however it is understood that other fluorescence disruption mechanisms can also work in the same way, for example fluorescence displacement, fluorescence dilution, and fluorescence obfuscation. In one example, when the sample comprises blood or a blood dilution, the presence of components in the blood cause a loss of fluorescence where the sample has been dispensed. In particular, the presence of metal-centered porphyrins such as haem in blood causes fluorescence quenching of fluorescent reporters. The imaging and detection of a sample spot in the sample addition area where the sample has been dispensed blocks the fluorescence transmission of the reporter deposited on the sample addition area of the assay membrane to confirm a correct dispense. In the first step a volume of a fluid sample is applied to a deposit area on a flow assay membrane having a fluorescence reporter deposited thereon 152. The fluorescent reporter is a species that is detectable in an imaging or wavelength detection range different than the fluid sample when excited by an illumination light source and can re-emit light of a different wavelength after light excitation from the illumination source at a first wavelength. When used with a fluorescent reporter, the fluid sample has at least one component that quenches the fluorescence of the fluorescent reporter at the deposit area. Fluorescent labels, such as fluorescent dyes and fluorescent proteins, offer several advantages compared to colorimetric labels in lateral flow assays, such as greater assay sensitivity, quantitative readout, and the possibility of multiplexing for simultaneous on-site measurement of different substances from a single sample. Commonly used fluorescent labels used in lateral flow assays include gold nanoparticles (GNP), quantum dots, fluorophores, and fluorescent microspheres. The sample addition area in the second step is then exposed to a light of a wavelength to excite the fluorescent reporter 154. The excitation light used in the exposure can be, for example, one or more light emitting diodes (LEDs), lasers, incandescent light sources, or fluorescent light sources. The next step is to image the membrane at the deposit area image deposit area to detect quenched fluorescence intensity of the fluorescent reporter on the membrane 156. Upon addition of the fluid sample to the deposit area fluorescence quenching of the fluorescent reporter by the sample fluid occurs when the sample fluid contains a component that disrupts fluorescence of the fluorescent reporter. Imaging of the loss in fluorescence intensity is such that quenched fluorescence intensity can be compared to a standard curve to determine the applied sample volume 158. The amount of fluid sample added to the deposit area is inversely proportional to the fluorescence intensity of the fluorescent reporter and the spot size increases with increasing applied sample volume. The imaging can be done by a device or component of a device that includes optical parts and is configured to capture images of the sample spot. The standard curve defines a correlation between the dispensed volume of fluid sample and the fluorescence intensity of the fluorescent reporter in the deposit area. The assay is then run with developing solution such that any analyte of interest in the sample flows to a test line 160, and the assay results are imaged at the results area to detect fluorescence intensity of the reporter at test line 162 whether it be the same reporter as used to assess the sample volume added or a separate reporter for measuring the analyte in question. Finally, using the applied sample volume and fluorescence intensity at the test line, the concentration of analyte of interest in the fluid sample can be determined 164 as an optional final step. After the assay has been run, the signal received at the test line signals on different assay membranes is not only proportional to a difference in sample volume added to the assay membrane, but also the concentration of analyte of interest in the sample fluid. The test line signal can be used to detect the concentration of analyte measured at the test line compared to a standard curve of test line fluorescence, optionally in combination with a volume normalization as discerned from the calculated volume of sample added. In one method, as long as the detected volume applied is within an acceptable range the signal at the test line can be used with the test line standard curve to approximate the concentration of analyte of interest in the sample fluid.

Lateral flow membrane analysis can be used to detect small amounts of small molecules and antibodies in very small volume samples. Because the amount of fluid sample added to a lateral flow membrane is very small (1-3 μL) it becomes difficult to calibrate the sample volume added, and lack of calibration of the sample volume added can lead to inaccuracy in investigating an analyte of interest in the sample. Additionally, without knowing the accurate amount of sample added to the assay device, a miscalculation can result in determining the amount of reagent that was added to the assay device which can affect any downstream quantitative calculations. In an example, if the chromatographic strip being utilized receives too little sample, the reagent will not be properly apportioned with respect to the sample and thus an incorrect indication of the analyte presence is possible or a false negative will result. On the other hand, if too much sample is delivered the reagent supply may be insufficient to saturate the sample and can result in an error in detecting the analyte present, and quantitation thereof.

### Example 1

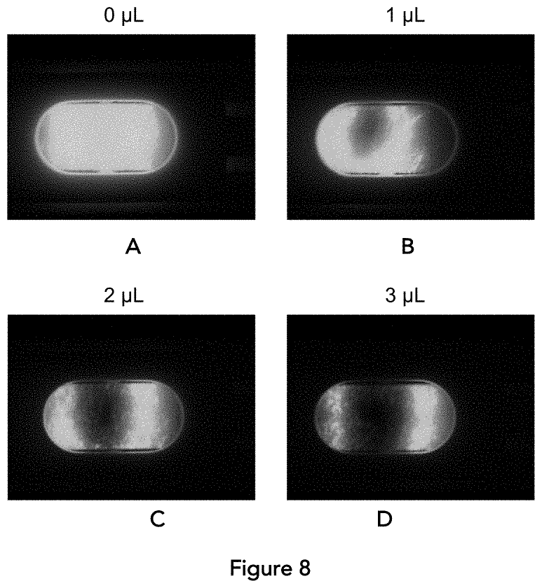

A set of lateral flow assay membranes were loaded with samples of varying volumes. The strip area or sample addition area at the sample port of each of the lateral flow assay membranes had previously been coated with Europium (0.05% Eu-Ab) which serves as the reporter. 0 μl, 1 μl, 2 μl, and 3 μl of whole blood was added to the sample addition area of four individual lateral flow assay membrane strips, each encased in a cartridge. A two second dwell time was added between the time that the sample was dispensed onto the sample addition area and the time that the sample was imaged in the imaging position. After the dwell time the cartridge was moved to the imaging position and an image was captured with an imaging time of three seconds. Each of the lateral flow assay cartridges was then imaged. Examples of imaging for sample volume normalization are shown in FIG. 8, which is a set of photographic images of the deposit area with varying amounts of added sample. Two 365 nm UV-A LEDs were used to illuminate each lateral flow membrane strip, causing the Eu to fluoresce at 625 nm. A filter blocks the excitation wavelength and passes the emission wavelength. The resulting image is captured by a RGB camera, and the red band image was analyzed. As shown in FIG. 8, the volume of sample added was (A) 0 μL; (B) 1 μL; (C) 2 μL; and (D) 3 μL. The spot size where the sample volume is evident in the images, and the fluorescence darkening of the membrane comprising the fluorescent Eu reporter is also evident in the loss of signal intensity as the volume of applied sample increases. The oval outline is the outline of the sample port in the cartridge. As shown in panel B, upon addition of 1 μL of fluid sample to the sample deposit area the fluorescence intensity of the fluorescent reporter decreases. As the location of the sample spot is evident in the sample addition area, the non-fluorescing area outside the spot can also be normalized as not related to sample-induced fluorescence disruption or quenching. As the amount of fluid sample added to the deposit area increases the fluorescence intensity of the fluorescent reporter decreases. When the amount of fluid sample added to the deposit area is 0 μL the unbroken fluorescence is emitted by the fluorescent reporter and the fluorescent intensity is 25.26 a.u., with a decrease in intensity with increased sample volume. The volume of sample applied to the membrane and reporter intensity result is shown in Table 1 below.

TABLE 1

| Dispensed Volume (uL) | Spot Width (Pixels) | Intensity (a.u.) |
|---|---|---|
| 0 | 0 | 25.26 |
| 1 | 593 | 16.53 |
| 2 | 877 | 13.19 |
| 3 | 1053 | 9.87 |

The image is normalized against calibration data that scales the image intensity to produce a uniform image across all systems. Previous camera calibration steps can be used to determine the pixel scaling factor used to convert pixels to mm dimensions. For image analysis, a region of interest (ROI) in the image was selected corresponding to the area of the sample deposit window, and all image data outside this region was ignored. Image analysis techniques were used to segment the region coated with the blood sample (dark area) from the background (bright red area, shown as bright white in FIG. 8 panel A). The segmentation threshold is determined in a preceding calibration step, in which the sample port area average pixel intensity is calculated. This may also be calculated for each assay device prior to sample dispense, or may be previously calibrated. The segmented sample area can be analyzed to determine the pixel area of the sample, as well as the relative intensity of the sample area. The calibrated pixel scaling values are used to transform the sample area pixels to real world units, for example, into mm². This area can then be related to sample volume. In another embodiment, upper and lower bounds on acceptable intensity and/or surface area of the applied sample can provide an indication that a suitable sample volume was added to achieve the required result precision.

A quality control metric can also be applied based on the volume of fluid sample added to the sample addition area by determining whether the sample volume added falls within an appropriate range. For example, a particular assay requires a minimum amount of analyte of interest in the sample to produce a detectable change or detectable test line in a results area, and if the minimum concentration is not supplied in the sample fluid the test line will read as a negative result. If less than an expected amount of sample volume is added then a negative result will occur if the sample does not have a high concentration of analyte of interest. Conversely, if too much sample fluid is added the test line can be overloaded and the positive result provided would be much higher than expected, even potentially nullifying the result of a sensitive assay with a false positive. In an automated system, a quality control metric can determine whether the surface area, change in optical intensity, or both, are indicative of a sample volume in a desired range. If the desired range is met then the test cartridge can be found to have been adequately run. If the quality control metric determines that the sample volume added was either less or more than the volume range requirements, the assay test can be suppressed of any subsequent analyte measurement made.

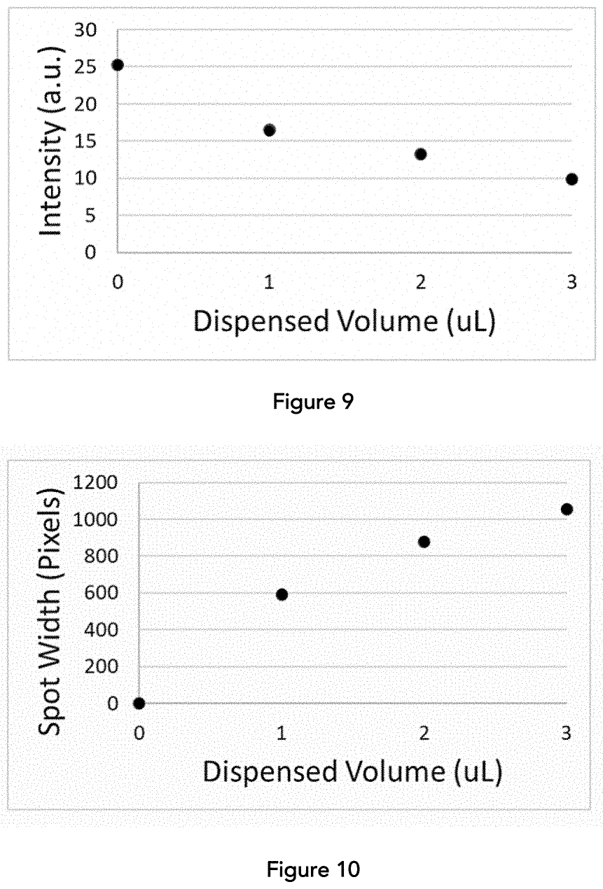

FIG. 9 is a graph of spot intensity vs. dispensed sample volume. A standard curve is prepared by plotting a graph of different amount of fluid sample dispensed at the deposit area against fluorescence intensity exhibited by the fluorescent reporter at the deposit area upon dispensing respective fluid sample. The fluorescence intensity captured by the imaging the membrane at the deposit area from the standard curve is then correlated with the volume of fluid sample applied to determine the volume of the fluid sample added at the deposit area.

Referring to FIG. 10, a standard curve for the spot width vs. dispensed volume of the fluid sample at the deposit area. The width of the sample spot can be used to determine the volume of fluid sample dispensed in the deposit area. The shown standard curve can be used to determine the amount of sample volume added to the LFA membrane by comparing a spot of detected with to a known volume. After imaging of the sample addition port, a developing solution was added (1% Tween 20, 1% Triton X-100, 0.03% ProClin 300 in 1×PBS (75 μL)) to run the assays.

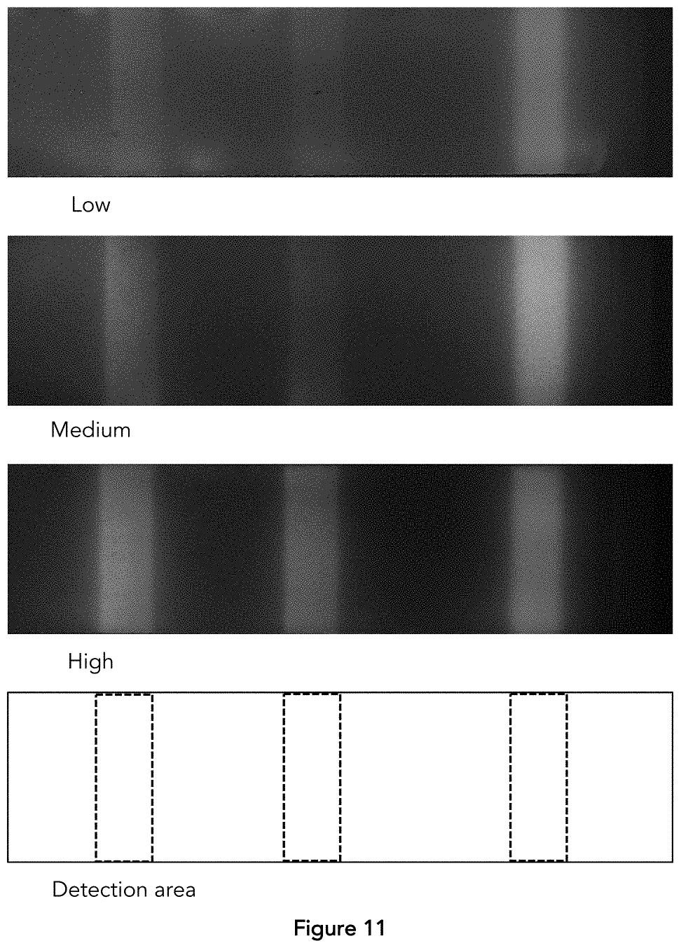

FIG. 11 is a photograph of the results area of low, medium, and high signal intensity results from three different assay runs with identification of the binding locations of test and control lines on the assay membrane at the detection area. These images represent potential variability that can add to result imprecision due to inaccurate addition of sample volume. With sample volume normalization the sample volume added to the assay can be incorporated into the assay result to provide a more accurate indication of the test results. Further, more accurate quantification of the concentration of an analyte in a sample of interest can be done based on the calculated volume of analyte added to the assay membrane in combination with the detected imaged result of the analyte with fluorescent marker at the test line.

An automated analyser can also be used to detect a volume of sample added to the sample area before an assay is run in the case where the sample added is detectable on the membrane by the imaging device even without a detector species. Preferably, illumination during imaging provides improved detection, and the wavelength and intensity of the illumination can be modified to optimally illuminate the sample spot. In one example, a sample of blood or diluted blood can be added to the sample area and then visualized to detect where sample has changed the visual or optical characteristics detected by the imaging device, evidenced by a change in color. The change can be analysed to extrapolate the volume of sample added in a similar manner as is done when a detector species is present, however in this case the volume analysis can be done in the absence of a detector species as the color of the sample is sufficient to detect the spot size and volume of sample added. A method of data analysis similar to that used in the case of a detector can be used, and the quantification of sample volume can be determined using a change in intensity detected at the imaging device, change in spot shape, change spot size, or a combination thereof. In a similar manner, a colored species that does not interfere with the assay can be added to the sample such that the sample spot can be visualized in the absence of a detector species previously applied to the membrane at the sample area. The color difference between the area of the membrane that received the spot and the area around the sample spot can be detected by the imaging device, optionally with additional illumination. Other sample types that may have pre-existing color detectable by the illumination device include, for example, biological samples and environmental samples.

The device, apparatus, and method of the present invention can be used for various types of assays, including but limited to immunoassays, immunochemistry assays, immunohistochemistry assays, immunocytochemistry assays, immunoblotting assays, immunoprecipitation assays, nucleic acid assays, nucleic acid hybridization assays, northern blotting assays, southern blotting assays, DNA footprinting assays, microarrays, nucleic acid sequencing, polymerase chain reaction (PCR) assays, ligation assays, cloning assays, nephelometry assays, and cell aggregation assays, and any variations or combinations thereof. In some embodiments, the assay is a sandwich assay, in which capture agent and detection agent are configured to bind to analyte at different locations thereof, forming capture agent-analyte-detection agent sandwich. In some embodiments, the assay is a competitive assay, in which analyte and detection agent compete with each other to bind to the capture agent. In some embodiments, the assay is a nephelometry assay that is used to determine the levels of several blood plasma proteins, such as but not limited to immunoglobulin M, immunoglobulin G, and/or immunoglobulin A. In some embodiments, the assay is an immunoassay, in which protein analyte is detected by antibody-antigen interaction. In some embodiments, the assay is a nucleic acid assay, in which nucleic acids (e.g. DNA or RNA) are detected by hybridization with complementary oligonucleotide probes.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method of fluid sample calibration comprising:
applying a volume of a fluid sample to a sample addition area of a membrane of an assay device, the deposit area comprising a fluorescent reporter, the fluid sample comprising at least one fluorescence disruptor component that disrupts the fluorescence of the fluorescent reporter; and
imaging the sample addition area to detect the disruption of fluorescence in the fluorescent reporter in the deposit area prior to running an assay,
wherein the disruption of fluorescence of the fluorescent reporter in the sample addition area is indicative of the volume of the fluid sample deposited on the sample addition area.

2. The method of claim 1, wherein the sample addition area is partially covered or fully covered by the fluorescent reporter.

3. The method of claim 1, wherein the assay device is a lateral flow assay device further comprising, downstream the sample addition area, a detection area comprising at least one test line and at least one control line, and a wicking area

4. The method of claim 1, wherein the fluorescent reporter is one or more of a fluorescent dye, fluorescent latex bead, fluorescent enzyme detection conjugate, gold nanoparticle, silver nanoparticle, titanium nanoparticle, europium fluorophore, and quantum dot.

5. The method of claim 1, further comprising determining whether the volume of fluid sample applied to the sample addition area is above an acceptable threshold or within an acceptable range.

6. The method of claim 1, further comprising determining the volume of the fluid sample applied to the deposit area by comparing the fluorescent signal of the reporter in the deposit area before the sample fluid is added to the fluorescent signal of the reporter after the fluid sample is added.

7. The method of claim 1, further comprising adding a developing solution to run the assay.

8. The method of claim 7, further comprising:
imaging an assay result at a test line;
quantifying an amount of analyte of interest captured at the test line; and
calculating a concentration of an analyte of interest in the sample fluid using the amount of analyte of interest captured at the test line and correcting for the calibrated volume of fluid sample applied to the sample addition area.

9. The method of claim 1, further comprising calculating the volume of fluid sample added to the sample addition area by comparing the disruption of fluorescence of the fluorescent reporter to a standard curve.

10. The method of claim 1, wherein a quality control metric is applied based on the volume of fluid sample added to the sample addition area, and wherein the quality control metric determines the suppression of any subsequent analyte measurement made.

11. The method of claim 1, wherein the volume of the fluid sample is between about 0.2 μl and 10 μL.

12. The method of claim 1, wherein the fluid sample comprises blood.

13. The method of claim 1, wherein the fluid sample is diluted prior to application on the membrane.

14. The method of claim 1, wherein the fluid sample is a biological fluid sample.

15. The method of claim 1, wherein the fluid sample is applied by an automated device or syringe.

16. The method of claim 1, further comprising applying developing solution to the flow assay membrane to run the assay and detect an analyte of interest.

17. A diagnostic analyser comprising:
a fluid dispense area comprising a sample conduit for dispensing a sample volume in a sample spot onto a lateral flow assay membrane at a sample addition area, and a developing solution conduit;
an imaging area comprising a light source for illuminating the assay membrane and an optical detection device for imaging the assay membrane;
a shuttle comprising a movement mechanism to move the lateral flow assay membrane between the fluid dispense area and the imaging area, the lateral flow assay membrane comprising a sample addition area with a fluorescent reporter, a detection area comprising a binding molecule, and a capture ligand capable of capturing and localizing at least one analyte of interest from the sample volume in the detection area of the assay membrane; and
a processor assembly for quantification of the dispensed sample volume to the sample addition area based on a fluorescence image collected by the optical detection device after sample addition and prior to an assay run, wherein the processor employs an interpretive algorithm stored in a computer readable format to (i) calculate a fluorescence intensity of the sample spot, and (ii) convert the sample spot fluorescence intensity to a quantification of the sample volume dispensed at the sample addition area.

18. The analyser of claim 17, further comprising a control system for controlling movement of the cartridge shuttle.

19. The analyser of claim 17, wherein the algorithm compares the sample spot intensity to a calibration curve.

20. The analyser of claim 17, wherein the light source emits at a fluorescence wavelength and the detector is a fluorescence detector.

21. A method of sample volume normalization comprising:
applying a volume of a fluid sample to a deposit area on a flow assay membrane, the deposit area comprising a fluorescent reporter, the fluid sample comprising at least one fluorescence disruptor component that disrupts the fluorescence of the fluorescent reporter;
exposing the fluorescent reporter at the deposit area to light of a wavelength to excite the fluorescent reporter;
imaging the membrane at the deposit area by detecting a fluorescence intensity of the fluorescent reporter in the deposit area; and
determining the volume of the fluid sample applied to the deposit area by comparing the fluorescence intensity at the deposit area to a standard curve,
wherein the fluorescence intensity in the deposit area is correlated with the volume of fluid sample applied in the deposit area.
